(19) United States
(12) Patent Application Publication
(10) Pub. No.: US 2009/0144545 A1
(43) Pub. Date: Jun. 4, 2009

(54) COMPUTER SYSTEM SECURITY USING FILE SYSTEM ACCESS PATTERN HEURISTICS

(75) Inventors: Charulatha Dhuvur, Poughkeepsie, NY (US); Eli M. Dow, Poughkeepsie, NY (US); Marie R. Laser, Poughkeepsie, NY (US); Jessie Yu, Wappingers Falls, NY (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/947,010

(22) Filed: Nov. 29, 2007

(51) Int. Cl. H04L 9/00

(52) U.S. Cl. 713/165

(57) ABSTRACT

A system for computer system security using file system access pattern heuristics is provided. The system includes access patterns to establish nominal read and write frequencies to a file system using heuristics, dynamic policies, and a policy manager. The policy manager monitors accesses to the file system to determine read and write access frequencies to the file system. The policy manager also compares the read and write access frequencies to the access patterns, and determines whether the read and write access frequencies exceed the access patterns per the dynamic policies. The policy manager further identifies an attack on the file system in response to exceeding the dynamic policies, where the identified attack is associated with a communication path to the file system. The policy manager additionally modifies an aspect of access via the communication path in accordance with the attack response in the dynamic policies to mitigate the attack.

### BACKGROUND OF THE INVENTION

1. Field of the Invention

This invention relates to computer-based file system security, and particularly to computer system security using file system access pattern heuristics.

2. Description of Background

Computer system security is a major concern for many businesses. Detecting and reacting to potential attacks over a network is a difficult task, even for the best system administrators. When administrators are alerted by intrusion detection systems and firewalls of anomalous activity, they must figure out what has happened and how to deal with the problem. One approach to performing computer system security is to monitor network traffic for excessive attempts to gain access to the computer system. However, once an intruder achieves access to the network, attacks on a file system interfaced to the network may go unnoticed. Many existing security systems provide no feedback about file system attacks. For example, using legitimate network connections to attack the file system may be undetectable by network traffic based detection systems.

Therefore, it would be beneficial to develop an approach to monitor file system activity to identify a potential attack upon the file system that does not rely upon network traffic monitoring. Such file system monitoring should be transparent to users of the file system to avoid burdening users with additional access steps while minimizing false positives in identifying an attack. Moreover, the file system monitoring should be dynamic to respond to changing conditions in establishing baseline access policies. Accordingly, there is a need in the art for computer system security using file system access pattern heuristics.

### SUMMARY OF THE INVENTION

The shortcomings of the prior art are overcome and additional advantages are provided through the provision of a system for computer system security using file system access pattern heuristics. The system includes access patterns to establish nominal read and write frequencies to a file system using heuristics, dynamic policies defining read and write access frequency limits and an attack response, and a policy manager. The policy manager performs a method that includes monitoring accesses to the file system to determine read and write access frequencies to one or more files in the file system. The method also includes comparing the read and write access frequencies to the access patterns, and determining whether the read and write access frequencies exceed the access patterns beyond the read and write access frequency limits defined in the dynamic policies. The method further includes identifying an attack on the file system in response to exceeding the dynamic policies, where the identified attack is associated with a communication path to the file system. The method additionally includes modifying an aspect of access via the communication path in accordance with the attack response in the dynamic policies to mitigate the attack.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECT

As a result of the summarized invention, technically we have achieved a solution which provides computer system security using file system access pattern heuristics.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts an example of a system employing system security using file system access pattern heuristics; and

FIG. 2 depicts a process for computer system security using file system access pattern heuristics in accordance with exemplary embodiments.

The detailed description explains the preferred embodiments of the invention, together with advantages and features, by way of example with reference to the drawings.

### DETAILED DESCRIPTION OF THE INVENTION

Exemplary embodiments, as shown and described by the various figures and the accompanying text, provide computer system security using file system access pattern heuristics. In exemplary embodiments, an autonomic security system is employed to protect the integrity of a file system from an attacker. The autonomic security system uses artificial intelligence to monitor and react to file system access attempts while remaining invisible to users of the file system. The autonomic security system monitors accesses to the file system to discover and record file system access patterns. The autonomic security system may also use file system metadata to establish patterns for specific file types. For example, the file system metadata may identify specific file types as read-write or read-only. In exemplary embodiments, the autonomic security system develops access patterns for files, classifying select files in the file system as read-often, write-often, read-infrequent, write-infrequent, or a combination thereof. For instance, a configuration file may be a read-write file, with an access pattern of read-often and write-infrequent, since under normal usage conditions the configuration file is frequently read but rarely updated. The configuration file can be identified by a file extension (e.g., “.cfg”) or other information in the file system metadata. The file system metadata can also include time of day information indicating specific times of day that files are accessed. The access patterns may incorporate the time of day information, e.g., establishing an expected time of day for higher file access frequencies, such as when file backups are performed. The access patterns can be established by file type, including sub-classifications, down to specific files depending upon the desired level of granularity and sensitivity of data in the files.

Once access patterns are established for the file system, attempted accesses to the file system can be monitored to determine whether the attempted accesses deviate sufficiently from the access patterns to classify the attempted accesses as abnormal, thus triggering a defensive response to a presumed attack. In exemplary embodiments, dynamic policies are developed to identify and respond to an attack. The dynamic policies may be updated according to a heuristic rule engine that refines the dynamic policies as an increasing number of accesses and/or attacks are observed within the file system. An administrator can also update the dynamic policies to establish initial thresholds to identify an attack, as well as default responses. Further details regarding computer system security using file system access pattern heuristics are provided herein.

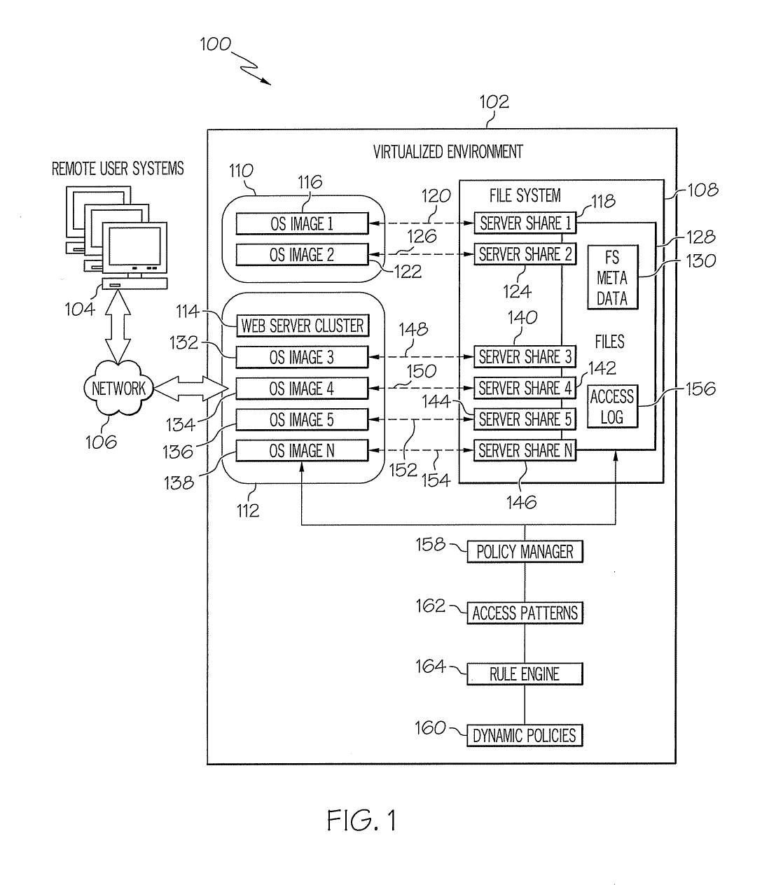

Turning now to the drawings, it will be seen that in FIG. 1 there is a block diagram of a system 100 employing system security using file system access pattern heuristics that is implemented in accordance with exemplary embodiments. The system 100 of FIG. 1 includes a virtualized environment 102 in communication with remote user systems 104 via a network 106. The virtualized environment 102 may include any type of computer system known in the art. For example, the virtualized environment 102 can include a single computer or multiple computers, including one or more mainframe computers, desktop computers, laptop computer, general-purpose computers, or embedded computers (e.g., within a wireless device). In exemplary embodiments, the virtualized environment 102 executes computer readable program code, which can be distributed between one or more processing circuits implementing a method embodied within the computer readable program code as read from a storage medium. The remote user systems 104 include may be personal computers, laptops, or other Web-enabled devices capable of interfacing with the virtualized environment 102. The network 106 may be any type of communications network known in the art. For example, the network 106 may be an intranet, extranet, or an internetwork, such as the Internet, or a combination thereof for linking remote user systems 104 to the virtualized environment 102. The network 106 can include wireless, wire, and/or fiber optic links.

In exemplary embodiments, the virtualized environment 102 includes a file system 108. The file system 108 can be a network file system, a distributed file system, a shared disk file system, a virtual file system, or another file system architecture known in the art. The virtualized environment 102 may also include a private virtual machine (VM) 110 and a public VM 112. In exemplary embodiments, the private VM 110 is accessible within the virtualized environment 102 but does not connect to systems external to the virtualized environment 102. The public VM 112 can pool multiple Web servers via a Web server cluster 114, providing an access point for computer systems external to the virtualized environment 102, such as the remote user systems 104. The private VM 110 can access the file system 108 using one or more operating system (OS) images. For example, an OS image one 116 accesses the file system 108 through a server share one 118 across a link 120, such as a network file system mount. A second OS image, OS image two 122, can access the file system 108 through an independent communication path, i.e., server share two 124 via a link 126, allowing reads and/or writes to files 128 in the file system 108. Although two VMs are depicted in the virtualized environment 102, the scope of the invention is not so limited, as there may be any number of private and/or public VMs in the virtualized environment 102. Moreover, the private VM 110 and public VM 112 can exist on separate servers or on the same hardware platform. The private VM 110 and public VM 112 can support multiple OS images, for example, Linux® images running on IBM® z/VM®.

The file system 108 also includes file system metadata 130. The file system metadata 130 can hold information about the files 128 in the file system 108. For example, the file system metadata 130 may identify specific file types as read-write or read-only. The file system metadata 130 may also include access permissions associated with the files 128. The file system metadata 130 can also include time of day information indicating specific times of day that the files 128 are accessed.

Similar to the private VM 110, the public VM 112 can access the file system 108 over multiple independent links. For example, OS image three 132, OS image four 134, OS image five 136, up to OS image N 138 can independently connect to the file system 108 via server share three 140, server share four 142, server share five 144, up to server share N 146, across links 148, 150, 152, and 154 respectively. The server shares 118, 124, and 140-146 may be short message block (SMB) server shares for accessing the files 128 of the file system 108, enabling file sharing to multiple OS images. In exemplary embodiments, each of the links 120, 126, and 148-154 are independently severable should an attack be detected. Accesses to the file system 108 can be recorded in an access log 156, tracking specific OS images (e.g., OS image one 116-OS image N 138) initiating the accesses.

In exemplary embodiments, a policy manager 158 implements an autonomic security system for the file system 108 by monitoring accesses to the files 128 and applying dynamic policies 160 to compare attempted accesses to access patterns 162. If the policy manager 158 determines that accesses are being attempted that deviate sufficiently from the access patterns 162 (i.e., abnormal accesses), the policy manager 158 applies the dynamic policies 160 to determine a course of action. For example, the policy manager 158 can identify a specific OS image (e.g., OS image N 138) as an attacker and deny access requests. Alternatively, the policy manager 158 may immediately restore a backup copy of an accessed file, move an attacked file, notify a system administrator, reboot, and/or halt the public VM 112 or hardware components underlying the virtualized environment 102 in response to an attack.

The access patterns 162 may initially be developed by a trusted user to drive typical usage in a controlled environment in order to establish a baseline of normal accesses. For example, the access patterns 162 can classify select files 128 in the file system 108 as read-often, write-often, read-infrequent, write-infrequent, or a combination thereof. Classification may be performed on a per server share basis to establish threshold values for defining access frequencies as read-often, write-often, read-infrequent, or write-infrequent. The policy manager 158 can also modify the access patterns 162 to adapt to changes that occur gradually over time using heuristics. Heuristic adjustments allow the access patterns 162 to be modified as an increasing number of accesses are monitored over time, which represent a fundamental shift in normal file 128 usage patterns, rather than an attack. The access patterns 162 may also incorporate time of day information from the file metadata 130, e.g., establishing expected times during the day for higher file access frequencies, such as when file backups or virus scans are expected to be performed. File system 108 access rate limits can be applied over a configurable learning window to establish and adjust the access patterns 162. The policy manager 158 may monitor accesses to the file system 108 in real-time or periodically parse the access log 156 to determine whether the access patterns 164 should be updated or if a violation of the dynamic policies 160 has occurred.

A rule engine 164 is used to create and modify the dynamic policies 160 using application specific heuristics. For example, the rule engine 164 can develop rate-limiting policies as threshold values for a number of read or write accesses per unit of time. The limits can vary depending on the application. For instance, a file logging system can establish limits in the dynamic policies 160 reflecting an expectation of relatively frequent writes and infrequent reads as compared to a general-purpose computer system experiencing a lower nominal write frequency. The rule engine 164 may modify the dynamic policies 160 in response to changes in the access patterns 162 to avoid incorrectly identifying an attack as the access patterns 162 change over time. The dynamic policies 160 can be adjusted on a per server share basis (e.g., different rates read/write rates permissible for server share two 124 versus server share three 140). Additionally, the dynamic policies 160 may be tiered such that greater degrees of policy violations result in a more severe response, e.g., move a file for a minor policy violation and terminate the associated OS image for a major policy violation. Furthermore, the dynamic policies 160 can include different responses at different times of the day, such as selecting from a list of various administrators to notify or modifying the severity of the response to an attack based on time of day.

Although the policy manager 158, dynamic policies 160, access patterns 162, and rule engine 164 are depicted separately in FIG. 1, it will be understood that they can be combined in any combination within the scope of the invention. Moreover, the policy manager 158, dynamic policies 160, access patterns 162, and rule engine 164 can be integrated into the file system 108 or exist external to the virtualized environment 102. While exemplary embodiments have been described in reference to a virtualized environment, the inventive principles embodied herein are not so limited. To the contrary, computer system security using file system access pattern heuristics can be implemented on a single computer system, such as a Web server, without using virtualization.

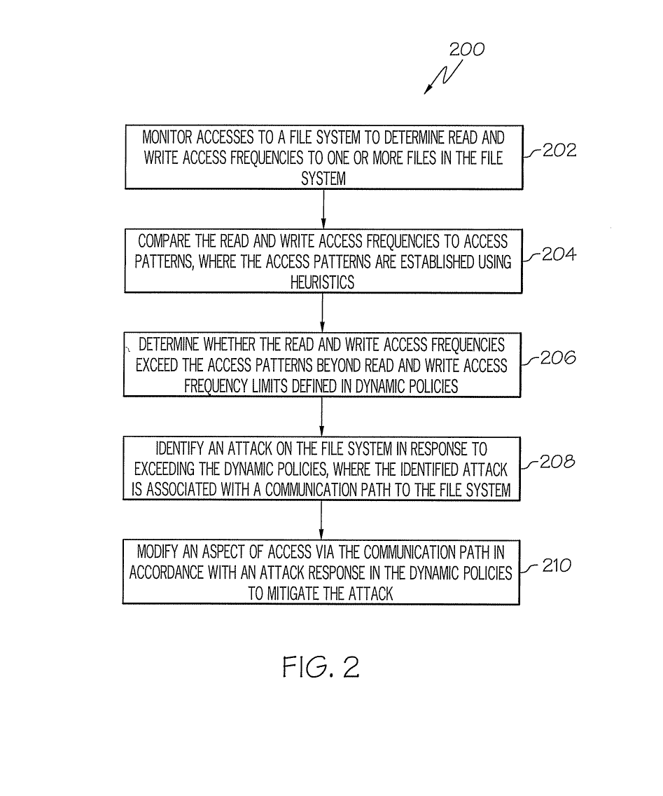

Turning now to FIG. 2, a process 200 for computer system security using file system access pattern heuristics will now be described in accordance with exemplary embodiments, and in reference to the system 100 of FIG. 1. At block 202, the policy manager 158 monitors accesses to the file system 108 to determine read and write access frequencies to one or more files 128 in the file system 108.

At block 204, the policy manager 158 compares the read and write access frequencies to the access patterns 162. The access patterns 162 may be adjusted using heuristics to refine the nominal read and write frequencies as an increasing number of accessed are performed over a period of time.

At block 206, the policy manager 158 determines whether the read and write access frequencies exceed the access patterns 162 beyond the read and write access frequency limits defined in dynamic policies 160. The rule engine 164 may adjust the read and write access frequency limits defined in dynamic policies 160 using heuristics to refine the limits as an increasing amount of accesses are observed.

At block 208, the policy manager 158 identifies an attack on the file system 108 in response to exceeding the dynamic policies 160, where the identified attack is associated with a communication path to the file system 108. The communication path may include a combination of an OS image (e.g., OS image one 116-OS image N 138), a link (e.g., link 120-link 154), and a server share (e.g., server share one 118-server share N 146). Alternatively, the communication path can be defined at a higher level, such as the private VM 110 or the public VM 112. The policy manager 158 can identify an attack on a per link basis, including an OS image and server share associated with the link.

At block 210, the policy manager 158 modifies an aspect of access via the communication path in accordance with the attack response in the dynamic policies 160 to mitigate the attack. The modification of an aspect of access can include a variety of responses, such as, denying access requests, immediately restoring a backup copy of an attacked file, moving an attacked file, notifying a system administrator of the attack, rebooting a computer component associated with the attack (e.g., a server used in the communication path), or halting a computer component associated with the attack (e.g., terminating the OS image or VM).

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system for computer system security using file system access pattern heuristics, the system comprising:
access patterns to establish nominal read and write frequencies to a file system using heuristics;
dynamic policies defining read and write access frequency limits and an attack response; and
a policy manager, the policy manager performing a method comprising:
monitoring accesses to the file system to determine read and write access frequencies to one or more files in the file system;
comparing the read and write access frequencies to the access patterns;
determining whether the read and write access frequencies exceed the access patterns beyond the read and write access frequency limits defined in the dynamic policies;
identifying an attack on the file system in response to exceeding the dynamic policies, wherein the identified attack is associated with a communication path to the file system; and
modifying an aspect of access via the communication path in accordance with the attack response in the dynamic policies to mitigate the attack.

2. The system of claim 1 wherein modifying the aspect of access includes one of: denying an access request, restoring a backup copy of an attacked file, moving the attacked file, notifying a system administrator of the attack, rebooting a computer component associated with the attack, and halting the computer component associated with the attack.

3. The system of claim 1 wherein the file system is part of a virtualized environment with the accesses to the file system received via one or more virtual machines, the communication path includes at least one link between one of the virtual machines and the file system, and further wherein identifying the attack is performed on a per link basis.

4. The system of claim 1 further comprising an access log to record the accesses to the file system, wherein the policy manager uses the access log to adjust the access patterns to account for changes in the nominal read and write frequencies to the file system.

5. The system of claim 1 wherein the file system further includes file system metadata, the file system metadata identifying specific file types to establish the access patterns.

6. The system of claim 5 wherein the file system metadata includes time of day information indicating specific times of day that the one or more files are accessed, and further wherein the access patterns and the dynamic policies incorporate the time of day information.

7. The system of claim 1 further comprising a rule engine, the rule engine applying heuristics to refine the dynamic policies as an increasing number of accesses to the file system are observed.
